(19) United States
(12) Patent Application Publication
(10) Pub. No.: US 2016/0055162 A1
(43) Pub. Date: Feb. 25, 2016

(54) Systems and Methods for Information Search, Retrieval, Summarization and Interpretation using Related-Concept Analysis

(71) Applicant: Coalesce, Inc., Dedham, MA (US)

(72) Inventor: Gregory J. Woolf, North Easton, MA (US)

(73) Assignee: COALESCE, INC., Dedham, MA (US)

(21) Appl. No.: 14/831,814

(22) Filed: Aug. 20, 2015

Related U.S. Application Data
(60) Provisional application No. 62/039,714, filed on Aug. 20, 2014.

(51) Int. Cl. G06F 17/30

(52) U.S. Cl. CPC G06F 17/3053; G06F 17/30554

(57) ABSTRACT

Systems and methods for searching text and textual content, and retrieving and summarizing and interpreting search results, are provided. The inventive systems and methods obtain content or are configured to be applied to content. The systems and methods review all of the content, creating one or more data collections of Related-Concept and Themes, and statistical relations between Related-Concepts and Themes. When a user enters a search query, the systems and methods present the user with Related-Concepts and Themes that match the search query, and the user can iteratively select Related-Concepts and Themes, and in response the present invention will narrow or broaden the search and display an altered documents results set and different Related-Concepts and Themes. The systems and methods then provide the user with interpretation about the content in the form of summaries or conclusions based on the Related Concepts and Themes.

### FIELD OF THE INVENTION

The present invention relates to searching for content on internet, networked or local storage media, and more specifically, to systems and methods for searching and summarizing that content using statistical relations base on linguistic concepts or themes.

### BACKGROUND OF THE INVENTION

Today's commercial search engines are tremendously powerful mechanisms to search for content across vast amount of content and documents, either online or within a company's network. The current art of search technology is extremely useful when users know specifically what content they are looking for. Yet, the strength of current search technology—returning thousands, millions, or tens of millions of results—is also a significant weakness. When a user doesn't know exactly what he or she is looking for, a search using the current search technology typically results in a frustrating and fruitless experience. Users rarely navigate beyond the first few pages of search results. Consequently, many users may never get to the critical information they may require, or the particular document they were looking for, if it is located on page 100 or page 1,000, or even on page 3, of the search results.

Furthermore, current search technology is not conducive to performing topical research where the results are not already known. Additionally, if the user must relate multiple concepts about a topic, or summarize content into a conclusion of their own making, the current search technology is inadequate. The volume of new content being added to the internet on a daily basis makes these problems worse every day. These failures of the current art of search technology are relevant for searching sets of documents or information internal to an organization, and for searching information available on the internet.

Furthermore, most organizations store tens of thousands of spreadsheets, word-processing files, presentations, and other documents across their internal systems, such as on network servers, databases, and employee computers. This presents a significant challenge to any organization that wants to identify and relate content contained in their documents without knowing the explicit location, path, and filename of the documents or data-records. Whether an organization chooses to centralize the storage of documents or not, the inability of any user to find desired content in an internal document is problematic for the organization, potentially resulting in significant and costly inefficiency and ineffectiveness.

Thus, there exists a need for users to find the critical information they need, even when a user doesn't know exactly what he or she is looking for. There is also a need for search technology that can assist a user in performing topical research where the results are not already known. Further, there exists a need for search technology that allows a user to relate multiple concepts about a topic, or to assist with summarizing content in a conclusion of their own making. Finally, there is a need for search technology that can quickly and efficiently allow users to find desired content, either in internal records or in external sources.

### SUMMARY OF THE INVENTION

The present invention meets all these needs, by disclosing systems and methods for analyzing content for related-concepts and themes (“RCTs”), and using those RCTs and statistical correlations among them to present to a user, in response to the user's search query, RCTs alongside the search results, so that the user may iteratively refine the search results. The user need not know in advance the concepts related to their search, because the inventive systems and methods dynamically provide the user with a list of related content and themes, which is updated with each iteration of the user's search refinement.

This summary introduces simplified concepts of related-concept searching which is further described in the Detailed Description below. This summary is not intended to identify essential features of the claimed subject matter, nor is it intended to be used to limit the scope of the claimed subject matter. Embodiments of the invention described here include systems and methods for implementing a RCT search, summarization of search results, and conclusions based on a machine-learning model. The present invention includes preprocessing of searchable content, either internal documents and data or external web-content, to identify and rank the RCTs contained in the content for the user's search.

The RCT search tool provides systems and methods for a user to enter a search query, and filter search results based on concepts which are statistically related to their initial search request. By doing so, the present invention allows the user to reduce the universe of results to a manageable results list, because the present invention tailors the results list to the user's interest and omits documents which are unrelated to the user's search. This allows a user to quickly and efficiently find desired content.

A RCT is a linguistic concept or theme. Each RCT has a statistical correlation to at least one other RCT based on the proximity of the RCTs in one or more documents. RCTs are not required to contain the same textual words to form a relationship. The relationship between RCTs contained in a document is determined by a statistical and linguistic algorithm (“SLA”). When the SLA is deployed or put in use on or for one or more files, the SLA constructs a RCT database consisting of RCTs and the statistical correlation between them. The SLA performs this function in advance of any search by any user. When a user desires to search using RCTs, the user enters text for an initial search. The SLA provides RCTs related to that text, and the user then selects one or more RCTs related to the user's initial search text. In response, the SLA narrows down the resulting document list. Each time the user adds or removes RCT filters, the resulting list of RCTs and related documents is updated to reflect the user's choices of RCTs, ranked by probability of accuracy.

The present invention provides a powerful tool to refine search results. A user may refine results based on one or more initial areas of interest, but the present invention also identifies RCTs about which the user may have been unaware. Thus, the present invention can be used to find critical information the user needs, even when a user doesn't know exactly what he or she is looking for. The invention can locate and highlight a critical piece of information related to the user's initial search query, even though it may be located in a document which is otherwise unrelated, and which would not be in any of the top pages of results if the user had used a traditional search engine. The present invention uses the user's RCT selections, allowing the user to follow the path of a critical topic to its summarization and conclusion based on RCTs. This can assist the user in performing topical research where the results are not already known.

The RCT search tool displays a list of documents, ranked by selected RCTs, that match the user's search query. When displaying the resulting document list, the system displays a brief summary or preview of each document's content by displaying a sample of sentences containing the user's selected RCTs. Thus the user is able to quickly determine whether the resulting documents are meeting the user's search requirements and thereby refine the search by selecting or deselecting additional RCTs to modify the direction of their search. The present invention's analysis, categorization, search based on, and display of RCTs enable the user to filter their search through content contained in the search results.

For each document displayed in the result list, the user can select to see a complete “Summary” which includes only sentences from the document which contain the selected RCTs, allowing the user to analyze the document content according the concepts and themes of their interest.

The RCT search tool provides the user with conclusions based on the user's selected RCTs using an expert system based on a machine learning model, as described below in greater detail. Based on the user's initial Search query and selected RCTs, the expert system identifies possible conclusions based on all RCTs to the user's search results ranked by probability.

As the amount of external and internal digital content grows exponentially, the related-concept search tool will prove to be an invaluable tool for any domain which involves detailed research for new ideas and thematic patterns, for example medical research, investment analysis, cultural and historical research, and scientific research. The present invention can quickly and efficiently allow users to find desired content, by analyzing an entire collection of content in advance for RCTs, and use them to allow the user to refine search results. By analyzing and drawing upon RCTs, and the statistical correlations between them, the present invention allows a user to relate multiple concepts about a topic and thereby make better decisions.

This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments, but the presently disclosed subject matter is not limited to the specific methods and instrumentalities disclosed. In the drawings, like reference characters generally refer to the same components or steps of the device or method throughout the different figures. In the following detailed description, various embodiments of the present invention are described with reference to the following drawings, in which:

FIG. 1 illustrates an exemplary method of the RCT process for parsing documents using a SLA to find RCTs and statistical correlations between them, ranking RCTs and building the RCT database.

FIG. 2 illustrates an embodiment of the inventive method for user-initiated searches.

FIG. 3 illustrates a method whereby the RCT process calculates and displays potential conclusions and their probabilities based on the user's selected RTC's using an expert system, in accordance with an embodiment of the present invention.

FIG. 4 is a block diagram providing a high-level overview for application and use of the system.

FIG. 5 is a block diagram illustrating in more detail an example of one system that provides an operating environment for software system that integrates component modules for identifying and ranking RCT's, and component modules that present search results in the form of RCTs, document list, contents summary and conclusion to users based on those RCTs.

FIG. 6 shows an example embodiment of a search screen, in which a user initiates a RCT search by entering a search query, in accordance with an embodiment of the present invention.

FIG. 7 shows an example embodiment of a results list screen and search filtering, based on the user's RCT search, in accordance with an embodiment of the present invention.

FIG. 8 shows an example embodiment of a search screen with RCTs for filtering results and with document previews, showing how the user can update the search filters and results by modifying their selected RCTs, in accordance with an embodiment of the present invention.

FIG. 9 shows an example embodiment of a search screen with RCTs for filtering results and with summarized document content, based on the user's search and selected RCT filters, in accordance with an embodiment of the present invention.

FIG. 10 shows an example embodiment of a screen displaying conclusions presented to the user based on user-selected RCTs and returned by the expert system, in accordance with an embodiment of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

An exemplary operating environment in which various aspects of the present invention may be implemented is described below in order to provide a general context for various aspects of the present invention.

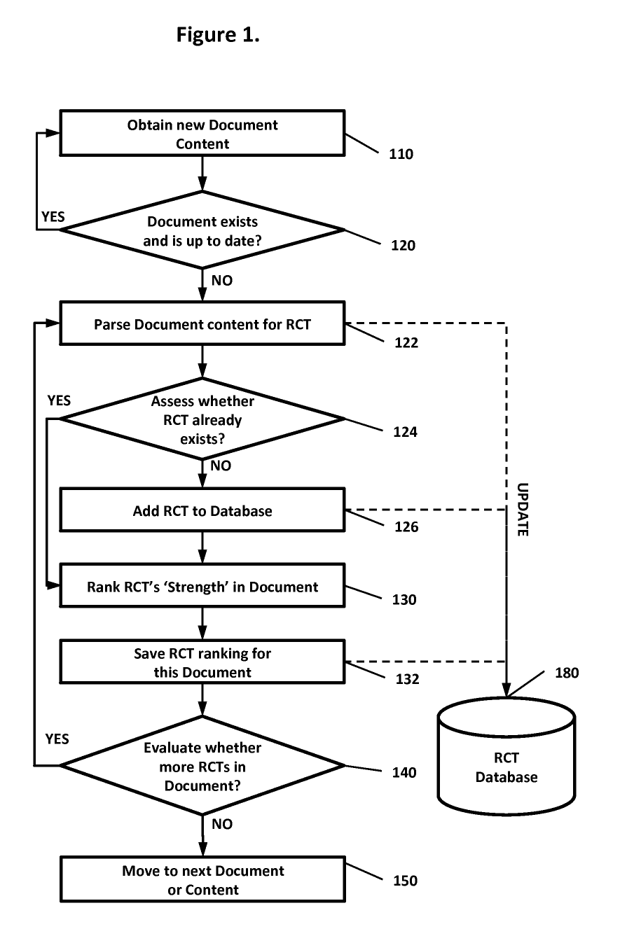

FIG. 1 illustrates an exemplary method of the RCT process 440 for parsing documents and content using a SLA to identify RCTs and the statistical correlations between them, ranking RCTs and building the RCT database 180. The RCT process 440 obtains 110 new document content 522, then checks 120 to see if the document content 522 exists in the RCT database 180 and is up to date. If the check 120 confirms that the documents or data exists and is up to date in the RCT database 180, the RCT process 440 continues to obtain 110 new document content 522, either contained in the documents subfolder or file path, or linked to the document via a new URL or as the next database record.

If the document does not exist or is an updated version of an existing document in the RCT database 180, the RCT process 440 parses 122 the document content 522, utilizing natural language processing tools including but not limited to n-grams (including but not limited to statistically significant two or three word phrases) and part-of-speech tagging (including but not limited to noun-phrase or verb-phrase), using the SLA to identify a statistically significant phrase or concept contained in the document content 522. The RCT process 440 then assesses 124 whether the resulting RCT is already in the RCT database 180. If the resulting RCT is not already in the RCT database 180, the RCT process 440 adds 126 the resulting RCT to the RCT database 180.

The RCT process 440 performs a statistical ranking 130 of the strength of the RCT directly after adding 126 the resulting RCT to the RCT database 180, or if the RCT was already in the RCT database 180, directly after assessing 124 whether the resulting RCT is already in the RCT database 180. The statistical ranking 130 of the strength of the RCT is based on factors including but not limited to the RCT's frequency of occurrence in the document, proximity to other RCTs, and relationship to other RCTs contained in the document. The RCT process 440 then saves 132 the ranking 130 in the RCT database 180. The RCT process 440 then evaluates 140 whether there are more RCTs in the document content 522, and if there are, the RCT process 440 repeats, parsing 122 the document content 522 for the remaining RCTs until there are no more in the document. When the RCT process 440 evaluates 140 the document content 522 for more RCTs and finds that there are no more RCTs, the RCT process 440 obtains a next 150 document content 522.

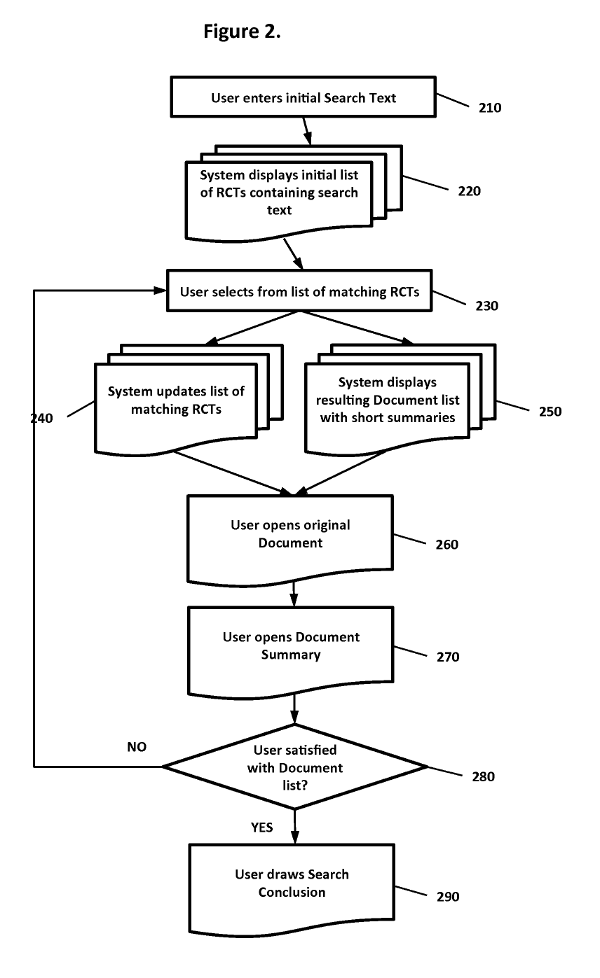

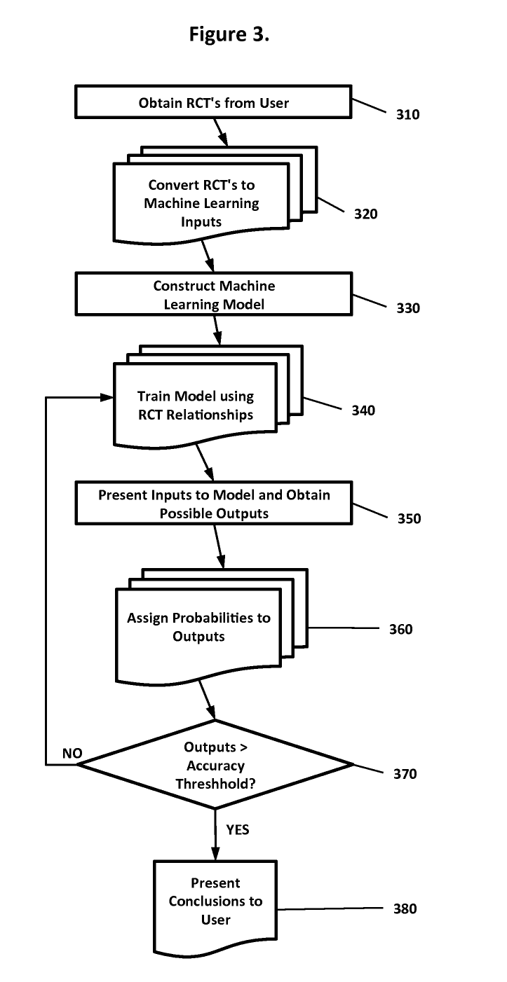

FIG. 2 illustrates an embodiment of the RCT search method conducted by the user, using the RCT process 440 and the user's selection of RCTs 230, to filter the resulting document list 250 and the original 260 or summarized 270 document content 522 based on the user's filtered selections, or draw conclusions 290 from the documents contained in the resulting document list 250 using a machine learning model described in FIG. 3.

The user initiates a search by entering initial search text 210 from the user device 510. The user device 510 contains a user interface 410 via a web-service API 430 that connects to the RCT process 440 to perform an initial match of the words contained in the user's initial search text 210 to RCTs in the RCT database 180. The RCT process 440 then displays to the user an initial list of RCTs 220 that contain one or more words from the user's initial search text 210. Thereafter, the user makes a selection of RCTs 230 from the initial list of RCTs 220 which most closely matches the initial search text 210.

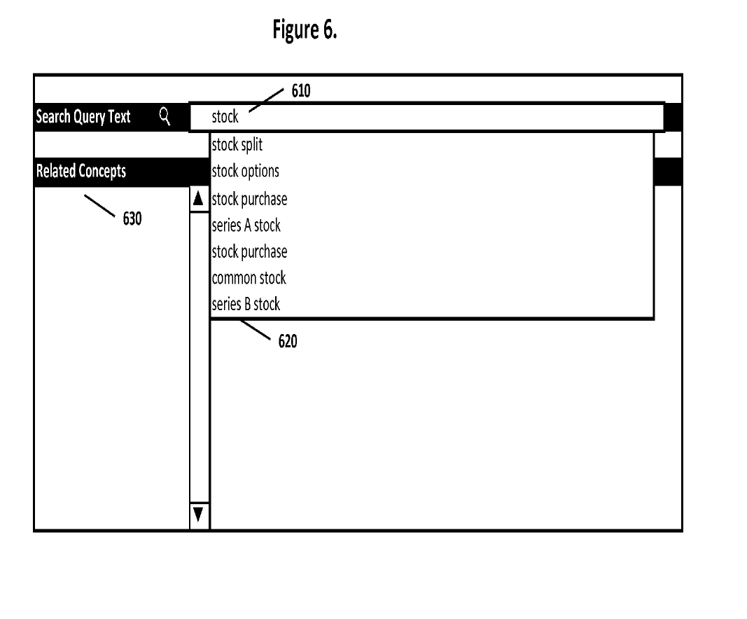

An example implementation of these elements of the method is illustrated in FIG. 6, which shows how a user has entered the search term “stock” in the search box 610 as the initial search text 210, and the RCT process 440 has returned initial RCT matches 620 from the RCT database 180 which contain the word “stock”, as the initial list of RCTs 220. Initially, the RCT display space 630 is empty until the user has made a selection of an RCT from the initial RCT matches 620.

The RCT process 440 then displays in the RCT display space 630 a list of RCTs 240 which are statistically correlated with the user's selection of RCTs 230 as calculated by the RCT identification and ranking method described in FIG. 1. Simultaneously, the RCT process 440 displays the resulting document list 250 that contain the matching RCTs, in descending order based on the aggregate strength of the statistical ranking 130 of all selected RCT's in each document stored in the RCT database 180.

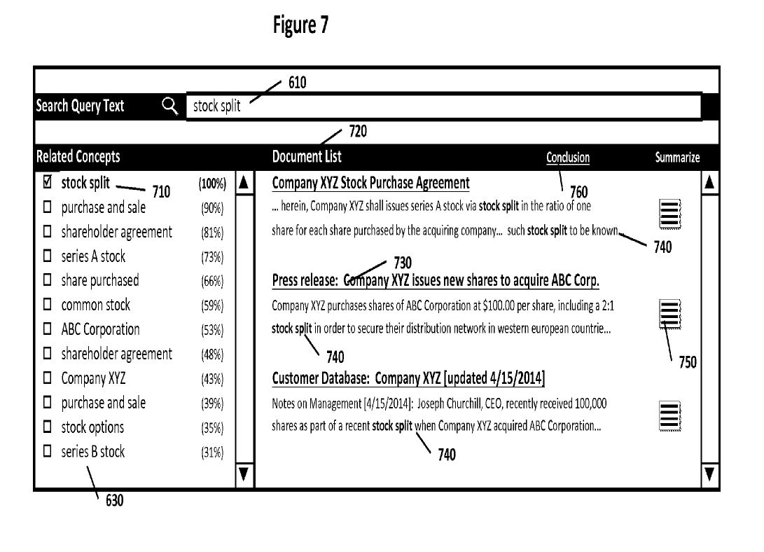

An example illustration of this aspect of the present invention is present in FIG. 7 which displays the initial search text 210, the initial selected RCT 710 and the list of additional matching RCTs in the RCT display space 630, and the document list 720 which most closely match the user's initial selected RCT 710. Under each document title 730 is a document content summary 740 containing sentences from the document content 522 which contain the initial selected RCT 710.

In a preferred embodiment of the present invention, the user then refines their search by making the user's selection of RCTs 230 which contain concepts or themes that best match the user's search objective. Each time the user modifies the user's selection of RCTs 230, the RCT process 440 updates the list of matching RCTs 240 and resulting document list 250 that most closely match the updated RCTs.

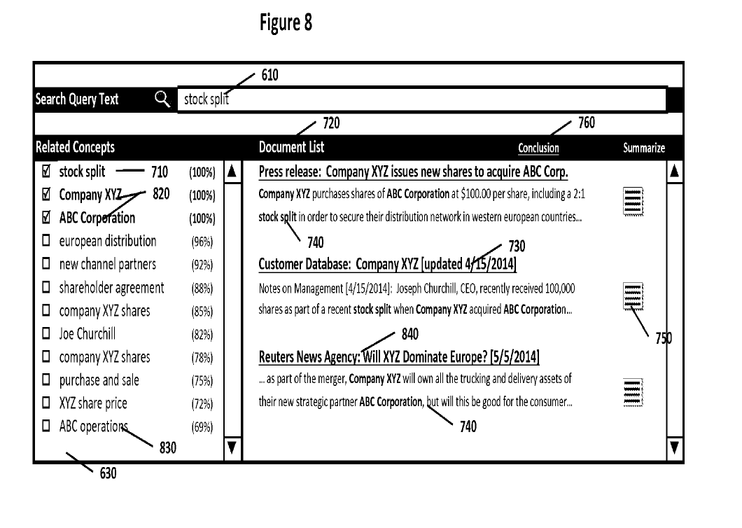

An example implementation of these elements of the method is illustrated in FIG. 8 which depicts the RCT display space 630 after the user has selected a plurality of additional RCTs 820 in addition to the initial selected RCT 710. The list of selected and unselected RCTs in the RCT display space 630 and the list of documents in the document list 720 have both been updated to reflect the users updated selection of, in the illustration of FIG. 8, additional RCTs 820 of “Company XYZ” and “ABC Corporation”, in addition to the initial selected RCT 710 of “stock split”.

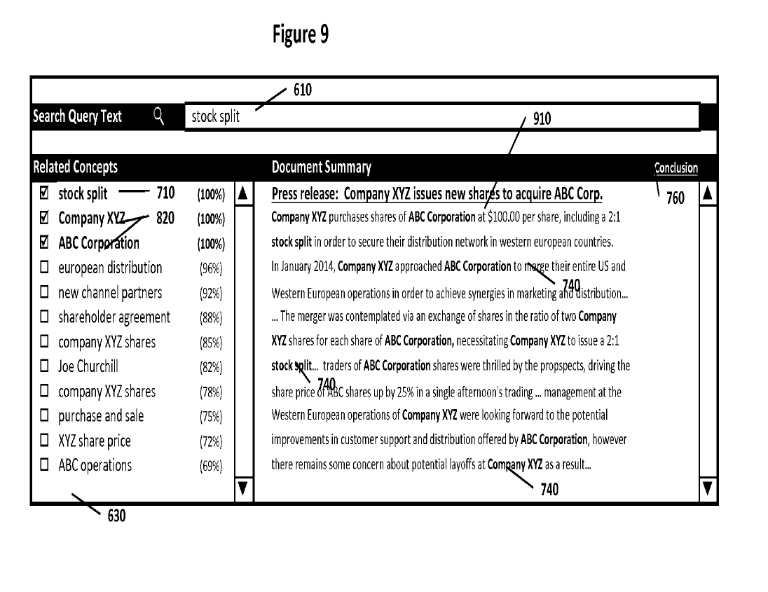

The user may iterate through the user's selection of RCTs 230 one or more times, as desired, selecting and unselecting RCTs 240 and reviewing the resulting document list 250 until the user is satisfied with the resulting document list 250. At any time in this iterative process the user can open 260 the original document from the resulting document list 250 or view a complete summary 270 as depicted in FIG. 9. All the user's selected RCTs are highlighted, meaning emphasized or marked, in the document list 720 or in the document content summary 910.

An example implementation of these elements of the method is illustrated in FIG. 9 which depicts a complete summary 270 for a single document selected by the user during the iteration process depicted in FIG. 2. The example interface is opened when the user clicks the button 750 in, or selects a document in another manner from, the document list 720, initiating the display of a new window with the document content summary 910. This content summary 270 includes all and only sentences from the original document content 522 that contain the either the user's initial selected RCT 710 or additional RCTs 820.

Once the user has completed the search and the user is satisfied 280 with the resulting document list 250, the user can obtain a conclusion 290 derived from the documents that match the user's selection of RCTs 230 using an expert system 570. An exemplary embodiment of this method is depicted in FIG. 3, and discussed in greater detail below.

FIG. 3 illustrates the method for presenting conclusions 380 based on the user's selection of RCTs 230 using an expert system 570 constructed from a machine learning model. Exemplary expert systems 570 could include but are not limited to Bayesian Networks, Neural Networks, Statistical Preference Engines or Logic Inference Systems.

Initially, the user initiates the expert system 570 as a final step of the search method described in FIG. 2. The expert system 570 obtains RCTs 310 from the user's selection of RCTs 230, and converts 320 the user's selection of RCTs 230 into machine learning inputs for the expert system 570. For instance, this could include normalizing each RCT's unique identity values, strength rankings, and relationships between them from the RCT database 180 into suitable values for a neural network algorithm.

The expert system 570 constructs 330 a machine learning model from the RCTs stored in the RCT database 180. The expert system 570 then trains 340 the machine learning model using the machine learning inputs which it converted 320 from the user's selection of RCTs 230.

Once trained, the expert system 570 presents the converted 320 machine learning inputs to the constructed 330 machine learning model to present 350 possible outputs and assigns probabilities 360 to outputs. The expert system 570 then compares 370 the assigned probabilities 360 of the outputs to a pre-defined accuracy threshold to determine the level of error. Output results which are above the accuracy threshold are presented to the user 380 by the conclusions presenter 568.

Outputs below the accuracy threshold, when compared 370 to the accuracy threshold, are used to retrain 340 the machine learning model and reiterate through a number of cycles to present to the user 380 conclusions, where the conclusions exceed the accuracy threshold 370 and are thus suitable to display to the user in the user interface 410.

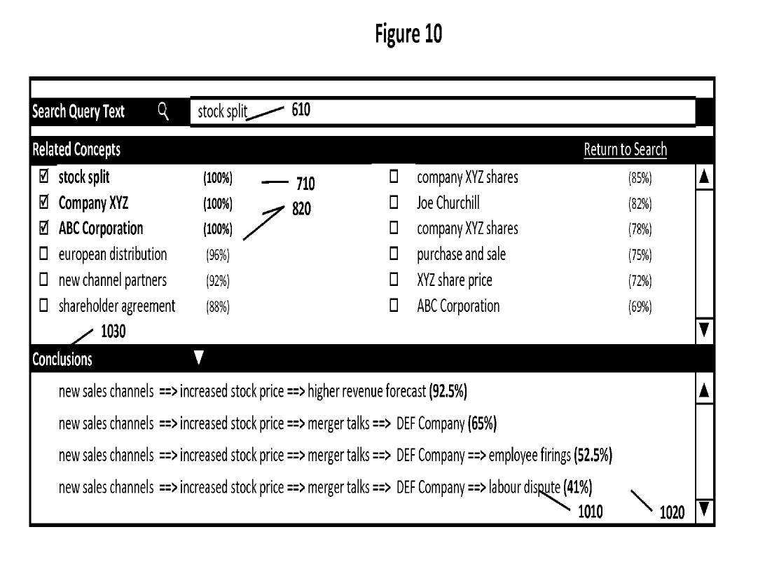

An example implementation of these elements of the method is illustrated in FIG. 10 which shows conclusions presented to the user 380 as described by the method depicted in FIG. 3. The user's initial selected RCT 710 and selected additional RCTs 820 are displayed in the page. Beneath these are conclusions 1030 calculated by the expert system 570 process which exceed the probability threshold 370 described in FIG. 3 and are thus suitable for display 380 to the user.

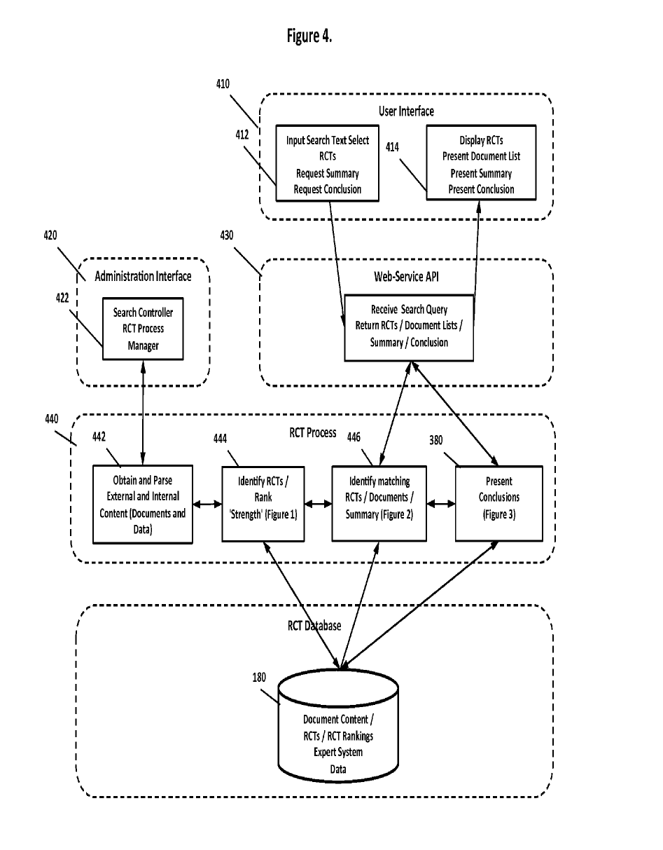

FIG. 4 is a block diagram providing a high-level overview for application and use of the system. The diagram depicts a preferred embodiment of the present invention, illustrating how the inventive systems and methods can create the RCT database 180, and how the inventive systems and methods interact with the user through an interface 410 based on their responses, as described in more detail below.

The RCT process 440 includes sub-processes to obtain 110 and parse 122 external or internal document and database content 442 for building the RCT database 180 in advance of the users search. This is achieved by identifying RCTs and ranking RCT ‘Strength’ 444 using the SLA and method set forth in FIG. 1, discussed above in greater detail.

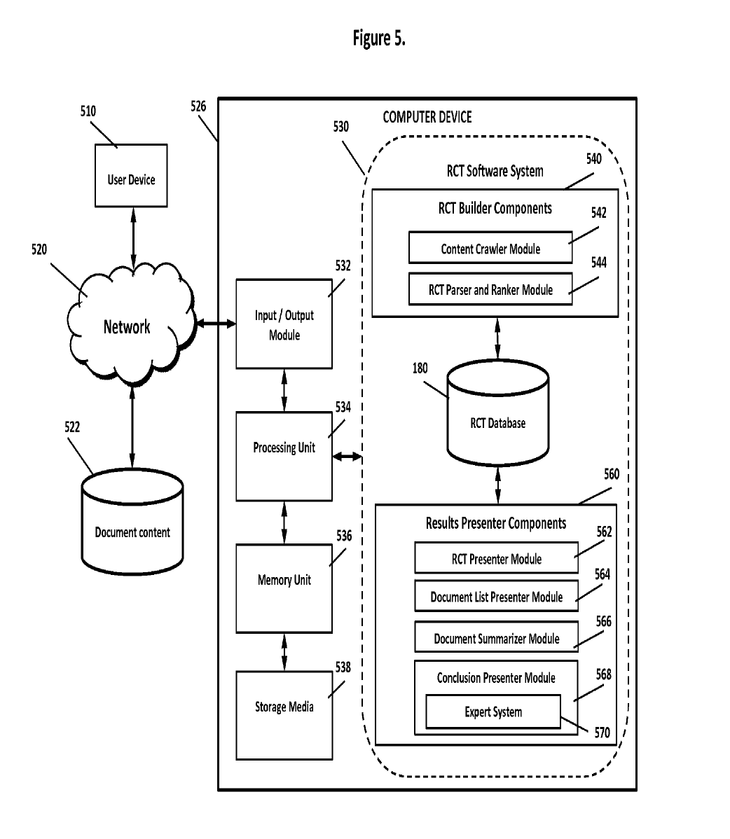

Building the RCT database 180 is controlled by an administration interface 420 which initiates, manages and reports on the RCT building process to an administrator user, distinct from an end user, via the search controller and RCT process manager 422. The administration interface 420 may be provided through executable code libraries which reside in the RCT process 440 on a computer device as depicted in FIG. 5, discussed below in greater detail.

User interaction with the invention is displayed on a user interface 410 on a user device described in FIG. 5. User inputs into the user interface 410 are comprised of search text, selected RCTs, requests for summaries and conclusions 412 as described by the method in FIG. 2, discussed above in greater detail.

The user interface 410 communicates with a Web Service Application Programming Interface (“Web Service API”) 430 which receives user inputs 412 and responds with system outputs 414 to display RCTs, or present document lists, summary content and conclusions based on the user's selections as illustrated in FIG. 2. The Web Service API 430 communicates with the RCT process 440 to identify matching RCTs, documents and summaries 446 and present conclusions 380 from the RCT database 180 as illustrated by the methods in FIG. 2 and FIG. 3, respectively.

An exemplary illustration of the detailed hardware and software components and modules of the embodiment of the system is described in greater detail in FIG. 5, as discussed below. Exemplary screen layouts of a preferred embodiment of the invention, illustrating the foregoing components of the inventive system, are presented in FIGS. 6-10, as described in greater detail below.

FIG. 5 illustrates a detailed example of one system that provides an operating environment for a system that integrates components for identifying and ranking RCTs, and components that present the results to a user's search query text in the form of RCTs, document list, content summaries and conclusion to users based on those RCTs.

The inventive system comprises a computer device 526, which interfaces with a plurality of user devices 510, referred to herein for simplicity as a user device. The inventive system also comprises a RCT software system 530, which executes the RCT process 440 on a computer device 526. The user device 510 and RCT software system 530 can communicate through a network 520, or in some embodiments of the invention, through a combination of one or more networks 520. The one or more networks 520 may be a local area network (LAN), a wide area network (WAN), the Internet, a cellular network, a peer-to-peer (P2P) network, a mobile network, or one or more other types of networks.

The user device 510 can be any kind of computing device or devices capable of initiating a RCT search as illustrated by the method described above, and depicted in FIG. 2. The user device 510 may be implemented as any one of a variety of conventional computing devices such as, for example, a desktop computer, a notebook or laptop computer, a netbook, a tablet or slate computer, a surface computing device, an electronic book reader device, a workstation, a mobile device (e.g., Smartphone, personal digital assistant, in-car navigation device, etc.), a game console, a set top box, or a combination thereof. Depending on the type of user device, user device may include, for example, a touch screen or other display, a keyboard, a mouse, a touch pad, a roller ball, a scroll wheel, an image capture device, an audio input device, an audio output device, and/or any other input or output devices. In some embodiments of the present invention, one or more of the components/modules of the RCT software system illustrated in FIG. 5 may be implemented as stand-alone applications. In other embodiments, one or more of the illustrated components/modules may be implemented via an operating system or integrated with an application running on one or more computing devices.

In some embodiments of the present invention, all communication between the user device 510 and the RCT software system 530 is undertaken over the network 520. The network 520 environment shown in FIG. 5 is an example of one suitable network environment and is not intended to suggest any limitation as to the scope of use or functionality of embodiments of the present invention. Neither should the exemplary network environment be interpreted as having any dependency or requirement related to any single component or combination of components illustrated therein. In other embodiments of the invention, the user device 510 and the RCT software system 530 may be implemented in a single device, or may directly communicate with one another.

The RCT software system 530 may be implemented on a variety of software and hardware platforms, including without limitation computer devices 526 such as web-servers, database servers using various architectures and designs, the number and specification of which may vary depending on the scale of each implementation. Each computer device 526 is comprised of physical or virtual computer components including a plurality of input/output modules, a plurality of processor units 534, a plurality of permanent storage and computer memory (or RAM) 536, a plurality of storage media 538, and include various software for operations such as operating systems, database servers, internet servers. The servers can be connected to the user device 510 via the network 520 by means of various networking equipment, including local and wide area cabling, satellite, wireless or Wi-Fi radio transmission.

In a preferred embodiment of the invention, the RCT software system 530 may obtain 110 document content 522 programmatically, by opening and reading content contained in target documents and databases using a content crawler module 542 to access the document content 522. The target document content 522 may consist of document-pages accessible over the network 520, external web-pages in various formats (including but not limited to html, aspx, or other web document formats) or internal documents (having common formats, including but not limited to Microsoft Office and Adobe PDF), or data contained in internal databases (including but not limited to Microsoft SQL Server and Outlook) located on an enterprise's network disk storage facilities, user laptops and workstations, or a combination of the above formats located on either an internal network or an external network 520, and the document content 522 depicted in FIG. 5 may be accessed over or using one or more network 520. The method for obtaining 110 document content 522 and identifying, storing and ranking the RCTs contained in the document content 522 is described in more detail in the discussion of FIG. 1, above. Document content 522 may include the document name, address (including but not limited to a URL or file network path, or database record identifier), date updated, and body textual information of any of the types of documents or data described above.

The RCT software system 530 locates new document content 522 via an existing network 520 path via the RCT builder component 540 to locate new document content 522 as described in FIG. 1. The RCT builder components comprise a content crawler module 542 which obtains 110 and parses 122 external and internal document and database content 442. The RCT builder component also comprises an RCT parser and ranker module which identifies RCTs and ranks their ‘Strength’ 444 to build the RCT data contained in the RCT database 180 according to the SLA method illustrated in FIG. 1.

When the user initiates a search as described in FIG. 2, the results presenter components 560 of the RCT software system 530 display RCTs from the RCT database 180 that match the users initial search text 210 and updated RCTs based on user subsequent selections 240 via the RCT presenter module 562. Similarly the document list presenter module 564 displays the resulting document list 250 from the RCT database 180. The document list presenter module 564 transmits the resulting document list 250 to the document summarizer module 566 to return short summaries of each document in the resulting document list 250 to be displayed with the resulting document list 250. The document list presenter module 564 and the document summarizer module 566 may also return to the user device 510 the original document content 260, and/or detailed document summaries 270. Furthermore, the results presenter components 560 provide the user with conclusions 290 about the resulting documents 250 via the conclusion presenter module 568 using the expert system 570 as illustrated in the method described by FIG. 3.

It will be understood by those of ordinary skill in the art that the components and modules illustrated in FIG. 5 are exemplary in nature and in number and should not be construed as limiting. Any number of components/modules may be employed to achieve the desired functionality within the scope of embodiments hereof. Further, components/modules may be located on any number of computing devices.

FIG. 6 is an exemplary user interface screen which shows how a user has entered an initial search text 210 (in this case “stock”) in the search box 610 and the RCT process 440 executing on the RCT software system 530 has returned a list of initial RCT matches 620 from the RCT database 180 (in this example which contain the word “stock”). The RCT display space 630 is empty until the user has made a selection of an RCT from the initial RCT matches 620, whereupon the RCT display space 630 and document list 720 are populated by the RCT process 440 as depicted in FIG. 7.

FIG. 7 illustrates a display to a user of the list of initial RCT matches 630 and document list 720 that were returned to the user via the RCT presenter module 562 and document list presenter module 564 based on the user's initial selected RCT 710. The user's initial selected RCT 710 is illustrated here as being in the RCT display space 630 (here, shown as a left-side panel) along with other ROTS 240 that relate to the users initial selected RCT 710 according to their ‘strength’ ranking per the SLA and method described in FIG. 1. Similarly, documents and their short summaries 250 that match the user's initial selected RCT 710 are displayed in the document list 720 region, here illustrated in a right-side panel.

Each matching document is displayed with a document title 730 and a brief document content summary 740. The document title 730 and document content summary 740 are presented by the document summarizer module 566 in a display that contains only sentences from the document content 522 that contain the user's selection of RCTs 230, as made by the user in the RCT display space 630. RCTs selected by the user in the RCT display space 630 may, in some embodiments, be highlighted in bold in the document content summary 740, as illustrated in FIG. 7.

The user can view the original document content 522 by clicking on the document title 730, which opens the document content 522 in a default viewing program (e.g., a web-page may open in a web-browser, or a PDF document may open in Adobe Acrobat). In some embodiments of the present invention, the user can click the Summarize button 750 to see the document text summarized, based on the user's selected plurality of RCTs 250 in the RCT display space 630 by the document summarizer module 566, as described below in greater detail. An exemplary illustration of the fully summarized document content 522 is illustrated in FIG. 9. By selecting or unselecting RCTs in the RCT display space 630, the user can control the document list 720 and short document content summary 740 according to the user's search preferences. By clicking the conclusion link 760, the user can initiate the expert system 570 that will present conclusions 290 based on the selected RCTs and matching document list 720 as illustrated in FIG. 10.

FIG. 8 shows an example of how the user can change the resulting

RCT matches 830 and document list 720 by selecting a different initial selected RCT 710 and additional RCTs 820 in the RCT display space 630. In this example, the user selects “Company XYZ” and “ABC Corporation” as additional RCTs 820 that were presented in the RCT display space 630 based on the initial search text 210. Upon making the selection of the additional RCTs 820, the RCT presenter module 562 and document list presenter module 564 update the list of resulting RCT matches 830 and the resulting document list 720 in the page, accordingly, to display an updated resulting document list 720 based on the initial selected RCT 710 (in the FIG. 8 example “stock split”) and additional RCTs 820 (in the FIG. 8 example “Company XYZ” and “ABC Corp”) based on the aggregate statistical ‘strength’ ranking of the additional RCTs 820 chosen by the user in the RCT database 180. In the FIG. 8 example, as a result of the user's selection of additional RCTs 820, a new RCT “ABC operations” is added to the list of resulting RCT matches 830 and displayed in the RCT display space 630 by the RCT presenter module 562, and a new document “Reuters News Agency: Will XYZ Dominate Europe” 840 is added to the document list 720 by the document presenter module 564.

FIG. 9 shows an example of the document content summary 910, as presented by the document summarizer module 566, that displays all document sentences that include only the initial selected RCT 710 and additional RCTs 820 selected by the user, as highlighted in bold in the document content summary 740. If the user makes RCT selection changes in the RCT selection area 630, the document summarizer module 566 redisplays the document content summary 910 to reflect the additional RCTs 820. In the example, the user's initial selected RCT 710 and additional RCTs 820 are highlighted 740 in bold in the document content summary 910 sentences.

FIG. 10 shows an exemplary illustration of the conclusions presented to the user 380 as described in FIG. 3. The user's initial selected RCT 710 and selected additional RCTs 820 are displayed in the page. Beneath these are conclusions 1030 calculated by the expert system 570 process described in FIG. 3 which exceed the probability threshold 380 and are thus suitable for display to the user by the conclusion presenter module 568.

An example format for presenting the conclusions in preferred embodiments of the present invention, may be “RCT1→RCT2Δ . . . RCT-n,” where each “→RCT” relationship is related to the previous RCT based on the statistical correlation identified by the expert system 570 using the conclusion derivation method illustrated in FIG. 3. All conclusions that exceed the accuracy threshold 370 are presented with a RCT conclusion result 1010 for the user to review, and for each RCT conclusion result 1010, the combined probability 1020 calculated by the expert system 570 is displayed.

The various modules described above may be implemented by computer-executable instructions, such as program modules, executed by a conventional computer device 526. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The computer device 526 may comprise or consist of a general-purpose computing device in the form of a computer including a processing unit, a system memory, and a system bus that couples various system components including the system memory to the processing unit 534. Computers typically include a variety of computer-readable media that can form part of the system memory and be read by the processing unit 534. By way of example, and not limitation, computer readable media may comprise computer storage media and communication media. The system memory 536 may include computer storage media in the form of volatile and/or nonvolatile memory such as read only memory (ROM) and random access memory (RAM). A basic input/output system (BIOS), containing the basic routines that help to transfer information between elements 532, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, Basic, C, C++, C#, COBOL, Forth, FORTRAN, Java, Lisp, Modula-2, Pascal, Prolog, Python, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media 538. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 534 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network 520 over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. It is expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Thus concludes description of exemplary systems and methods of the present invention described herein, whereby a user is able to filter their search results, displays summaries and draw conclusions based on concepts and themes statistically related to a search request. By doing so, the user reduces the universe of results to a manageable list tailored to their interest for interpretation and better decision making, and omits content unrelated to their search.

Accordingly, I claim:

1. A method for information search, retrieval, and interpretation for relevant results, the method comprising:
analyzing the content for a plurality of related-concepts and themes;
performing a statistical ranking of each of the plurality of related-concepts and themes; and
presenting search results with related-concepts and themes alongside the search results.

2. The method of claim 1, in which the step of analyzing content for a plurality of related-concepts and themes further comprises parsing the content utilizing natural language processing tools to identify the plurality of related-concepts and themes.

3. The method of claim 1, in which the step of analyzing content for a plurality of related-concepts and themes further comprises using a statistical and linguistic algorithm to identify the plurality of related-concepts and themes.

4. The method of claim 1, in which after the step of analyzing content for a plurality of related-concepts and themes, the method further comprises:
assessing whether each of the resulting plurality of related-concepts and themes is already in a related-concepts and themes database; and
adding one or more of the plurality of related-concepts and themes to the related-concepts and themes database if the one or more of the plurality of related-concepts and themes is not already in the related-concepts and themes database.

5. The method of claim 1, in which prior to the step of analyzing content for a plurality of related-concepts and themes, the method further comprises:
obtaining a first set of content;
checking to see if the content exists in a related-concepts and themes database; and
obtaining a second set of content if the first set of content exists and is up to date in the related-concepts and themes database.

6. A method for information search, retrieval, and interpretation of content using related-concepts and themes, the method comprising:
performing an initial match of the words contained in a user's initial search text to related-concepts and themes contained in a related-concepts and themes database;
displaying to the user an initial list of related-concepts and themes that contain one or more words from the user's initial search text; and
receiving from the user a selection of related-concepts and themes from the initial list of related-concepts and themes.

7. The method of claim 6, the method further comprising, after the step of receiving from the user a selection of related-concepts and themes, updating the list of matching related-concepts and themes and resulting document list.

8. The method of claim 7, the method further comprising allowing the user to iterate through the user's selection of related-concepts and themes a plurality of times.

9. The method of claim 6, the method further comprising presenting to the user the content from the search results or a summary thereof, with the user's selection of related-concepts and themes highlighted.

10. The method of claim 6, the method further comprising converting the user's selection of related-concepts and themes into machine learning inputs for an expert system.

11. The method of claim 10, the method further comprising constructing a machine learning model from the related-concepts and themes stored in the related-concepts and themes database.

12. The method of claim 11, the method further comprising training the machine learning model using the machine learning inputs.

13. The method of claim 12, the method further comprising presenting the machine learning inputs to the machine learning model to present possible outputs and assign probabilities to outputs.

14. The method of claim 13, the method further comprising comparing the assigned probabilities of the outputs to a pre-defined accuracy threshold to determine a level of error.

15. The method of claim 14, the method further comprising presenting to the user output results which are above the accuracy threshold.

16. The method of claim 14, the method further comprising using output results below the accuracy threshold to retrain the machine learning model.

17. A system for searching content for relevant results and filtering search results using related-concepts and themes, the system comprising:
a computer device, configured to communicate with a user device through one or more networks, and further comprising:
a plurality of input/output modules;
a plurality of processing units;
a plurality of memory units; and
a plurality of storage media; and
an RCT software system.

18. The system of claim 17, in which the RCT software system further comprises:
RCT builder components, comprising a content crawler module and an RCT parser and ranker module; and
Results presenter components, comprising a RCT presenter module, a document list presenter module, a document summarizer module, and a conclusion presenter module.

19. The system of claim 18, in which the RCT software system further comprises a RCT database.

20. The system of claim 17, in which the system further comprises a RCT database.
